(19) United States
(12) Patent Application Publication
(10) Pub. No.: US 2020/0180471 A1
(43) Pub. Date: Jun. 11, 2020

(54) DISPLAY DEVICE

(71) Applicant: TOYOTA JIDOSHA KABUSHIKI KAISHA, TOYOTA-SHI (JP)

(72) Inventors: Kenji TSUBOSAKA, Nagakute-shi (JP); Takahiko HASEGAWA, Toyota-shi (JP); Kimihiko TESHIMA, Miyoshi-shi (JP); Shunji INOUE, Okazaki-shi (JP); Takanori KITO, Miyoshi-shi (JP)

(21) Appl. No.: 16/679,755

(22) Filed: Nov. 11, 2019

(30) Foreign Application Priority Data
Dec. 6, 2018 (JP) 2018-229099

(51) Int. Cl. B60L 58/30; H01M 8/0444; H01M 8/04082; G06F 3/14

(52) U.S. Cl. CPC B60L 58/30; H01M 8/0444; H01M 2250/20; G06F 3/14; H01M 8/04201

(57) ABSTRACT

Provided is a display device for displaying information, the display device being provided in a movable body including a fuel cell, a storage portion in which fuel gas to be supplied to the fuel cell is stored, and a remaining amount measuring portion configured to measure an amount of the fuel gas in the storage portion. The display device includes a display portion configured to display the information, and a controlling portion configured to control the display portion. The controlling portion displays, on the display portion, the amount of the fuel gas stored in the storage portion based on information provided from the remaining amount measuring portion.

### INCORPORATION BY REFERENCE

The disclosure of Japanese Patent Application No. 2018-229099 filed on Dec. 6, 2018 including the specification, drawings and abstract is incorporated herein by reference in its entirety.

### BACKGROUND

### 1. Technical Field

This disclosure relates to a display device for a movable body including a fuel cell.

### 2. Description of Related Art

In the related art, in terms of a hydrogen remaining amount display device provided in a fuel cell vehicle, there has been such a technology that a predetermined display is performed based on a cruising distance, a space-part hydrogen gas remaining amount, and a material-part hydrogen remaining amount. On the right side of a display indicative of the material-part hydrogen remaining amount, a supply lower limit pressure in a hydrogen storage tank is displayed (Japanese Unexamined Patent Application Publication No. 2008-106817 (JP 2008-106817 A)).

### SUMMARY

However, a technology to clearly inform a user of a parameter peculiar to the movable body including a fuel cell still has room for improvement.

This disclosure is achievable in the following aspects.

(1) One aspect of this disclosure provides a display device for displaying information, the display device being provided in a movable body including a fuel cell, a storage portion in which fuel gas to be supplied to the fuel cell is stored, and a remaining amount measuring portion configured to measure an amount of the fuel gas in the storage portion. The display device includes: a display portion on which the information is displayed; and a controlling portion configured to control the display portion. The controlling portion displays, on the display portion, the amount of the fuel gas stored in the storage portion based on information provided from the remaining amount measuring portion. With such a configuration, the amount of the fuel gas stored in the storage portion as a parameter peculiar to the movable body including the fuel cell can be clearly informed to a user. (2) In the display device according to the above aspect, the controlling portion may display, on the display portion, an image of the storage portion in accordance with the amount of the fuel gas stored in the storage portion based on the information provided from the remaining amount measuring portion. The controlling portion may display, on the display portion, a value indicative of the amount of the fuel gas stored in the storage portion such that the value overlaps with the image of the storage portion. With such a configuration, the amount of the fuel gas stored in the storage portion can be informed to the user so that the user can intuitively grasp the amount of the fuel gas. (3) In the display device of the above aspect, the controlling portion may display, on the display portion, an amount of the fuel gas sent out from the storage portion per unit time based on the information provided from the remaining amount measuring portion. With such a configuration, the amount of the fuel gas sent out from the storage portion per unit time as a parameter peculiar to the movable body including the fuel cell can be informed to the user. (4) In the display device of the above aspect, the movable body may further include a moving amount measuring portion configured to measure a moving amount of the movable body. The controlling portion may display, on the display portion, a moving amount of the movable body per unit amount of the fuel gas based on: the amount of the fuel gas sent out from the storage portion per unit time, calculated based on the information provided from the remaining amount measuring portion, the amount of the fuel gas being an amount of the fuel gas sent out from the storage portion per unit time during a first time interval; and a moving amount of the movable body per unit time, calculated based on the information provided from the moving amount measuring portion, the moving amount being a moving amount of the movable body per unit time during a second time interval at least partially overlapping with the first time interval. With such a configuration, the moving amount of the movable body per unit amount of the fuel gas as a parameter peculiar to the movable body including the fuel cell can be informed to the user. (5) In the display device of the above aspect, the movable body may further include a load measuring portion configured to measure a weight of a load put on the movable body. The display device may display, on the display portion, a movable distance by the fuel gas stored in the storage portion, based on: the weight of the load, provided from the load measuring portion, the amount of the fuel gas stored in the storage portion, calculated based on the information provided from the remaining amount measuring portion, and the moving amount of the movable body per unit amount of the fuel gas. With such a configuration, the movable distance by the fuel gas stored in the storage portion can be informed to the user. (6) In the display device of the above aspect, the controlling portion may display, on the display portion, an image of the fuel cell, an image of the fuel gas sent out to the fuel cell, and an image of oxidation gas sent out to the fuel cell. The image of the fuel gas sent out to the fuel cell may be displayed in accordance with the amount of the fuel gas sent out from the storage portion per unit time. With such a configuration, a power generation state of the fuel cell can be informed to the user. (7) In the display device of the above aspect, the movable body may further include a time accumulation portion configured to accumulate a time required to fill the fuel gas into the storage portion from outside. The controlling portion may display, on the display portion, an accumulation value of the time acquired from the time accumulation portion. With such a configuration, the accumulation value of the time required to fill the fuel gas into the storage portion can be informed to the user.

This disclosure is achievable in various forms other than the display device. For example, the disclosure can be achieved in the forms of an information display method, a controlling method for a display device, a computer program to implement those methods, a non-transitory recording medium in which the computer program is stored, and so on.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an explanatory view illustrating a schematic configuration of a fuel cell vehicle 20 in a first embodiment;

FIG. 2 is a view illustrating a display D92 displayed on a display panel 91;

FIG. 3 is a view illustrating a display D93 displayed on the display panel 91;

FIG. 4 is a view illustrating a display D94 displayed on the display panel 91; and

FIG. 5 is a front view of the vehicle 20.

### DETAILED DESCRIPTION OF EMBODIMENTS

### A. First Embodiment

A1. Configuration of Fuel Cell Vehicle:

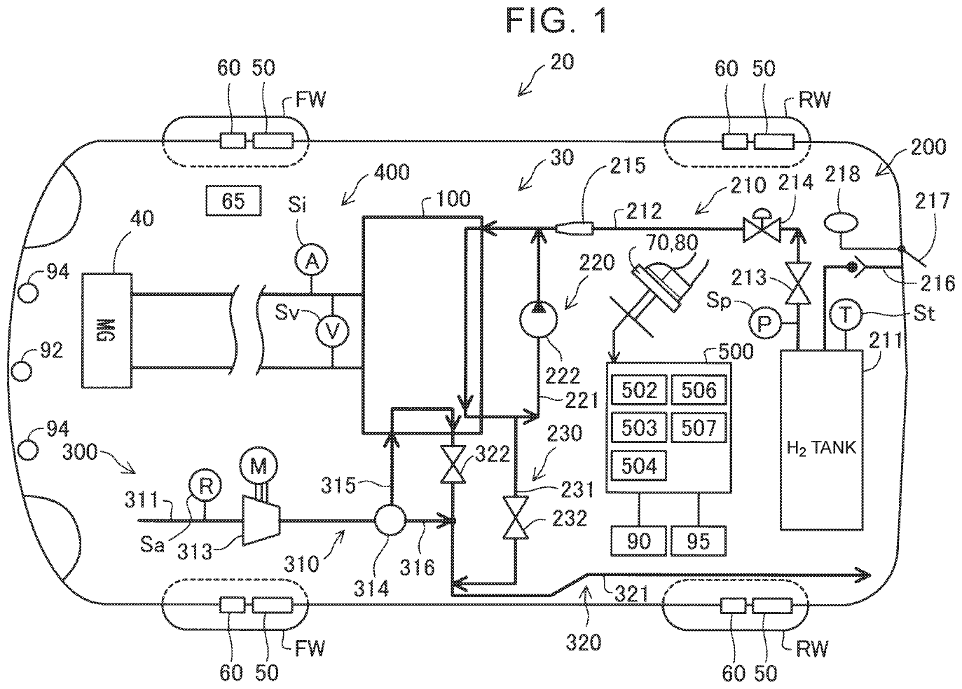

FIG. 1 is an explanatory view illustrating a schematic configuration of a fuel cell vehicle 20 in the first embodiment. The fuel cell vehicle 20 includes a fuel cell system 30, a motor 40, a friction brake 50, a vehicle speed detection portion 60, a weight sensor 65, an accelerator pedal 70, a brake pedal 80, a display device 90, an emblem 92, a light emission portion 94, a communication portion 95, and a vehicle controlling portion 500. Hereinafter, the fuel cell vehicle 20 is also just referred to as “vehicle 20.”

The fuel cell system 30 performs power generation by an electrochemical reaction between fuel gas and oxidation gas. A generated electric power is supplied to the motor 40 and is used as a driving force to move the vehicle. The fuel cell system 30 includes a fuel cell 100, a hydrogen supply-discharge system 200, an air supply-discharge system 300, and a power supply system 400.

The fuel cell 100 is a solid polymer fuel cell. The fuel cell 100 receives fuel gas and oxidation gas and performs power generation by an electrochemical reaction between the fuel gas and the oxidation gas. As the fuel gas, hydrogen gas is used. As the oxidation gas, air is used. The fuel cell 100 is provided with a voltage sensor Sv configured to measure an output voltage and a current sensor Si configured to measure an output current.

The hydrogen supply-discharge system 200 supplies hydrogen gas as the fuel gas to the fuel cell 100. The hydrogen supply-discharge system 200 discharges, to outside, reacted fuel gas discharged from the fuel cell 100 or supplies the reacted fuel gas to the fuel cell 100 again. The hydrogen supply-discharge system 200 includes a hydrogen supply portion 210, a hydrogen circulation portion 220, and a hydrogen discharge portion 230.

The hydrogen supply portion 210 supplies hydrogen gas as the fuel gas to the fuel cell 100. The hydrogen supply portion 210 includes a hydrogen tank 211, a hydrogen supply passage 212, a main stop valve 213, a pressure reducing valve 214, an injector 215, a hydrogen receipt passage 216, and a cover portion 217 (see the right upper part in FIG. 1).

The hydrogen gas to be supplied to the fuel cell 100 is stored in the hydrogen tank 211 in a high-pressure state. The hydrogen supply passage 212 is a passage via which the hydrogen tank 211 is connected to an anode passage of the fuel cell 100. The hydrogen supply passage 212 is provided with the main stop valve 213, the pressure reducing valve 214, and the injector 215 sequentially from the upstream side. When the main stop valve 213 is opened, high-pressure hydrogen gas stored in the hydrogen tank 211 flows toward the hydrogen supply passage 212. After the high-pressure hydrogen gas is depressurized to a predetermined pressure by the pressure reducing valve 214, the hydrogen gas is supplied from the injector 215 to the fuel cell 100 in response to a power generation request from the fuel cell 100.

A temperature sensor St is provided in the hydrogen tank 211. The temperature sensor St can detect a temperature of the hydrogen gas in the hydrogen tank 211. Further, in the hydrogen supply passage 212, a passage on the hydrogen tank 211 side from the main stop valve 213 is provided with a pressure sensor Sp. The pressure sensor Sp can detect a pressure of the hydrogen gas in the hydrogen tank 211.

The hydrogen receipt passage 216 is a passage via which the outside of the fuel cell vehicle 20 is connected to the hydrogen tank 211. The hydrogen receipt passage 216 supplies the hydrogen gas as the fuel gas supplied from the outside to the fuel cell 100. The hydrogen receipt passage 216 is provided with a check valve, and the hydrogen gas flows through the hydrogen receipt passage 216 only in a direction from the outside of the fuel cell vehicle 20 to the hydrogen tank 211. The cover portion 217 is provided in an open end of the hydrogen receipt passage 216. The cover portion 217 is a cover that closes the open end of the hydrogen receipt passage 216. Opening and closing of the cover portion 217 is detected by an opening-closing sensor 218.

The hydrogen circulation portion 220 supplies the reacted fuel gas discharged from the fuel cell 100 to the fuel cell 100 again. The hydrogen circulation portion 220 includes a hydrogen circulation passage 221 and a hydrogen circulation pump 222. The hydrogen circulation passage 221 is a passage via which the anode passage of the fuel cell 100 is connected to a passage on the downstream side from the injector 215 in the hydrogen supply passage 212 (see the central part in FIG. 1). The hydrogen circulation pump 222 is provided in the hydrogen circulation passage 221. Unconsumed hydrogen gas included in anode offgas discharged from the fuel cell 100 is circulated by the hydrogen circulation pump 222 through the hydrogen circulation passage 221, the hydrogen supply passage 212, and the fuel cell 100.

The hydrogen discharge portion 230 discharges reacted fuel gas discharged from the fuel cell 100, namely, anode offgas to the outside. The hydrogen discharge portion 230 includes a hydrogen discharge passage 231 and a gas-liquid discharge valve 232 (see the central lower part in FIG. 1). The hydrogen discharge passage 231 is a passage via which a passage between the fuel cell 100 and the hydrogen circulation pump 222 in the hydrogen circulation passage 221 is connected to an air discharge passage 321 (described later). The gas-liquid discharge valve 232 is provided in the hydrogen discharge passage 231. When the gas-liquid discharge valve 232 is opened, the anode offgas is discharged to atmosphere through the air discharge passage 321.

The air supply-discharge system 300 supplies the air as the oxidation gas to the fuel cell 100. The air supply-discharge system 300 discharges, to the outside, the reacted oxidation gas discharged from the fuel cell 100. The air supply-discharge system 300 includes an air supply portion 310 and an air discharge portion 320 (see the lower part in FIG. 1).

The air supply portion 310 includes an air introduction passage 311, an air flow meter Sa, an air compressor 313, a flow dividing valve 314, an air supply passage 315, and an air bypass passage 316 (see the left lower part in FIG. 1).

The air introduction passage 311 is a passage communicating with the atmosphere and is connected to the air supply passage 315 and the air bypass passage 316 via the flow dividing valve 314. The air introduction passage 311 is provided with the air flow meter Sa, the air compressor 313, and the flow dividing valve 314 sequentially from the upstream side. The air flow meter Sa is a sensor configured to detect a flow rate of the air introduced into the air introduction passage 311. The air compressor 313 is a compressor configured to introduce the air into the air introduction passage 311 and pump the introduced air to the fuel cell 100. The flow dividing valve 314 can adjust a flow rate of the air flowing to the air supply passage 315 and a flow rate of the air flowing to the air bypass passage 316.

The air supply passage 315 is a passage via which the flow dividing valve 314 is connected to a cathode passage of the fuel cell 100. The air bypass passage 316 is a passage via which the flow dividing valve 314 is connected to the air discharge passage 321 (described later). Note that the air bypass passage 316 may communicate with the atmosphere without being connected to the air discharge passage 321.

The air discharge portion 320 discharges, to the outside, reacted oxidation gas discharged from the fuel cell 100. The air discharge portion 320 includes the air discharge passage 321 and a pressure control valve 322 (see the right lower part in FIG. 1). The air discharge passage 321 is a passage connected to the cathode passage of the fuel cell 100 and communicating with the atmosphere. The pressure control valve 322 is provided in the air discharge passage 321. When the opening degree of the pressure control valve 322 is adjusted, the pressure of the air in the cathode passage of the fuel cell 100 and the flow rate of the air discharged by the air compressor 313 are adjusted.

The air bypass passage 316 and the hydrogen discharge passage 231 are connected to the downstream side from the pressure control valve 322 in the air discharge passage 321, sequentially from the upstream side. Cathode offgas discharged from the fuel cell 100 flows through the air discharge passage 321 together with the air flowing therein from the air bypass passage 316 and the anode offgas flowing therein from the hydrogen discharge passage 231 and is discharged to the atmosphere.

The power supply system 400 supplies an electric power supplied from the fuel cell 100 to the motor 40. More specifically, a direct-current power generated by the fuel cell 100 is boosted and then converted into a three-phase alternating-current power so as to be supplied to the motor 40. The power supply system 400 includes a power storage device in which the electric power supplied from the fuel cell 100 can be stored.

Upon receipt of electric powers from the fuel cell 100 included in the fuel cell system 30 and the power storage device included in the power supply system 400, the motor 40 drives wheels FW, RW of the fuel cell vehicle 20 so that the fuel cell vehicle 20 travels (see the left part in FIG. 1).

The friction brake 50 decelerates the fuel cell vehicle 20 by converting a kinetic energy of the fuel cell vehicle 20 into a heat energy by friction (see the right upper part, the right lower part, the left upper part, and the left lower part in FIG. 1). The friction brake 50 of the present embodiment is a disc brake driven by an actuator. The friction brake 50 is provided in each of the front wheels FW and the rear wheels RW.

The vehicle speed detection portion 60 detects a vehicle speed of the fuel cell vehicle 20, namely, a moving amount per unit time (see the right upper part, the right lower part, the left upper part, and the left lower part in FIG. 1). The vehicle speed detection portion 60 of the present embodiment detects a vehicle speed by use of a rotation speed of each wheel of the fuel cell vehicle 20, the rotation speed being obtained by a wheel speed sensor. The vehicle speed detected by the vehicle speed detection portion 60 is transmitted to the vehicle controlling portion 500. The vehicle speed detection portion 60 is provided in each of the front wheels FW and the rear wheels RW.

The weight sensor 65 can measure a weight of a load put on the fuel cell vehicle 20 (see the left upper part in FIG. 1). More specifically, the weight sensor 65 detects deformation amounts of support members that support rotating shafts of the wheels of the fuel cell vehicle 20 and calculates the weight of the load. The deformation of the support member that the weight sensor 65 uses may be an elastic deformation or a mechanic deformation. The weight detected by the weight sensor 65 is transmitted to the vehicle controlling portion 500.

The accelerator pedal 70 is an input device into which the user inputs an acceleration instruction (see the right upper part in FIG. 1). Information on a stepping amount of the accelerator pedal 70 is transmitted to the vehicle controlling portion 500. The vehicle controlling portion 500 accelerates the fuel cell vehicle 20 by controlling each part of the fuel cell vehicle 20 in accordance with the stepping amount of the accelerator pedal 70.

The brake pedal 80 is an input device into which the user inputs a deceleration instruction (see the right upper part in FIG. 1). Information on a stepping amount of the brake pedal 80 is transmitted to the vehicle controlling portion 500. The vehicle controlling portion 500 decelerates the fuel cell vehicle 20 by controlling each part of the fuel cell vehicle 20, including the friction brake 50, in accordance with the stepping amount of the brake pedal 80.

The display device 90 is controlled by the vehicle controlling portion 500 such that the display device 90 displays information to the user in the fuel cell vehicle 20 (see the right lower part in FIG. 1). Further, the display device 90 receives an input from the user. The display device 90 includes a display panel 91 including a touch panel and placed at a generally central position in the vehicle width direction, the position being a position facing a driver seat and a front passenger seat in the fuel cell vehicle 20. Various pieces of information are displayed on the display panel 91. The pieces of information to be displayed on the display panel 91 will be described later.

The emblem 92 is provided in the center of the front face of the vehicle 20. The emblem 92 indicates a vehicle or a manufacturer of the vehicle. The emblem 92 can emit light in various colors. The light emission portions 94 are provided on a front bumper of the vehicle 20, at respective positions on right and left lower sides from the emblem 92. The light emission portions 94 can also emit light in various colors.

The communication portion 95 is controlled by the vehicle controlling portion 500 such that the communication portion 95 transmits information about the fuel cell vehicle 20 to other vehicles (see the right lower part in FIG. 1). Further, the communication portion 95 is controlled by the vehicle controlling portion 500 such that the communication portion 95 receives pieces of information about other vehicles from those other vehicles. The pieces of information transmitted and received by the communication portion 95 will be described later.

The vehicle controlling portion 500 is configured as a computer including a CPU, a memory, and an interface circuit to which each part is connected (see the right lower part in FIG. 1). The vehicle controlling portion 500 controls each part of the fuel cell vehicle 20 based on pieces of information acquired from various sensors.

A2. Display on Display Panel:

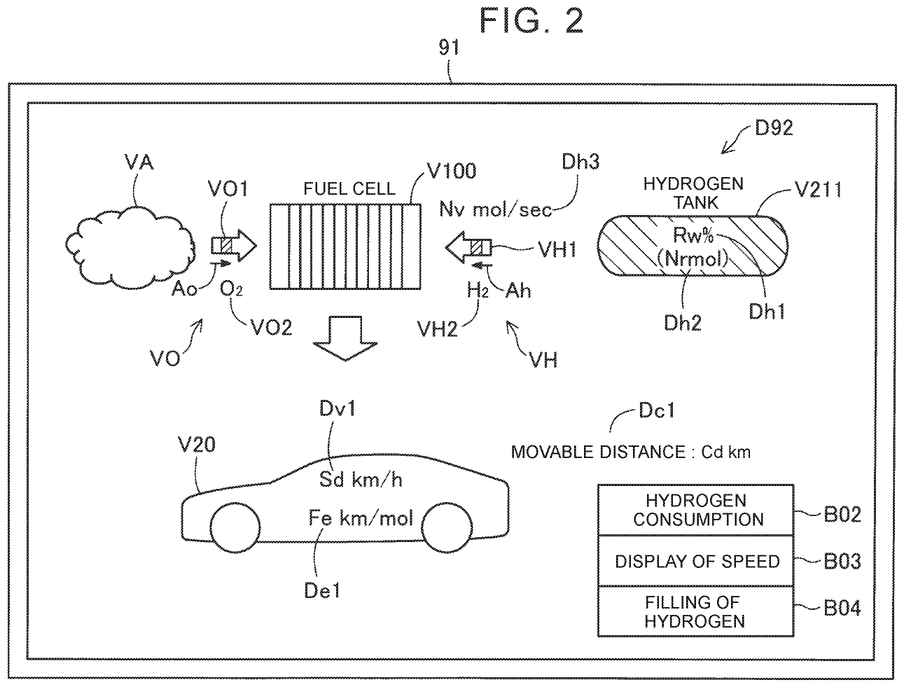

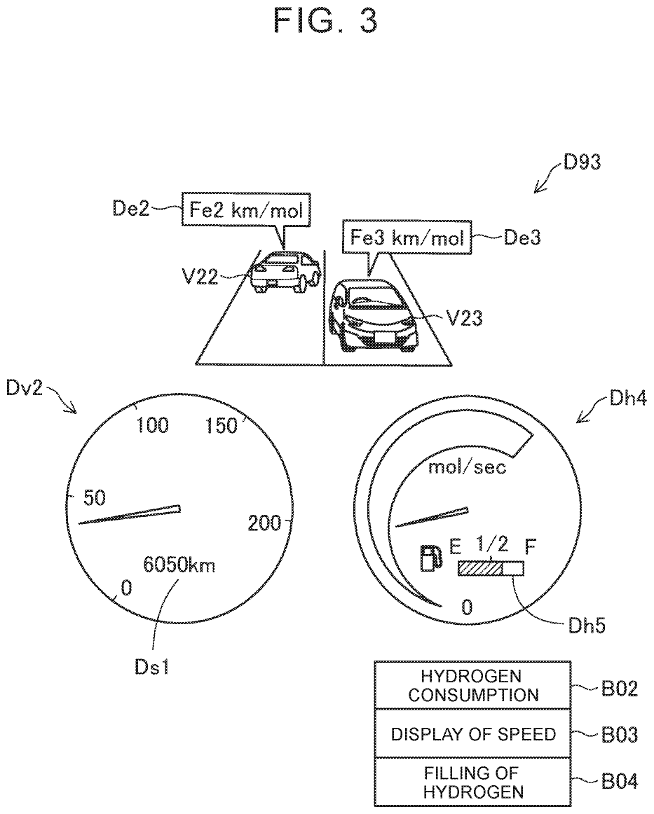

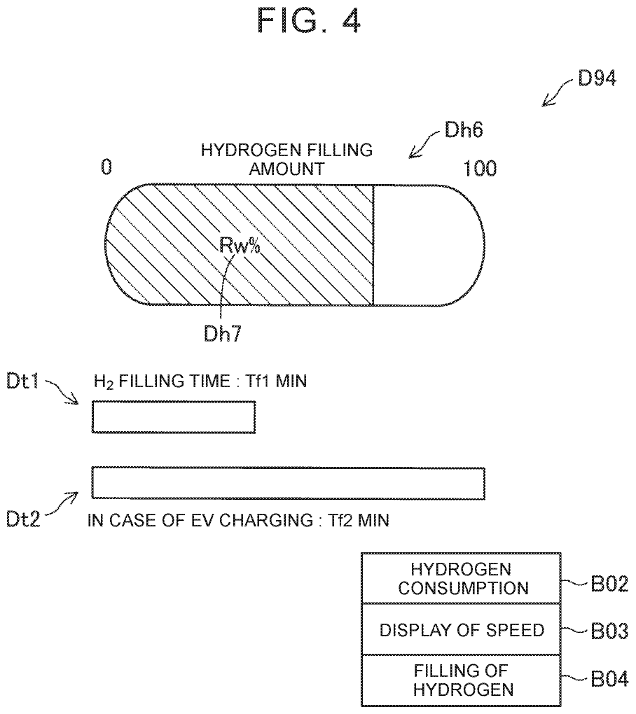

FIG. 2 is a view illustrating a display D92 displayed on the display panel 91 (see the right lower part of FIG. 1). The display D92 is a display indicative of a state where hydrogen is consumed in the fuel cell vehicle 20. The display panel 91 is controlled by the vehicle controlling portion 500 such that the display D92 illustrated in FIG. 2, a display D93 illustrated in FIG. 3, and a display D94 illustrated in FIG. 4 can be selectively displayed on the display panel 91. The display D93 illustrated in FIG. 3 and the display D94 illustrated in FIG. 4 will be described later.

The display D92 illustrated in FIG. 2 includes an image V20 indicative of the fuel cell vehicle 20, an image V100 indicative of the fuel cell 100, an image V211 indicative of the hydrogen tank 211, an image VA indicative of the atmosphere, an image VH indicative of hydrogen sent out to the fuel cell 100 from the hydrogen tank 211, an image VO indicative of oxygen sent out to the fuel cell 100 from the atmosphere, and display switch buttons B02 to B04.

The vehicle controlling portion 500 calculates an amount Nr of hydrogen stored in the hydrogen tank 211 based on latest information from among pieces of information on the pressure of the hydrogen gas in the hydrogen tank 211, provided from the pressure sensor Sp, and latest information from among pieces of information on the temperature of the hydrogen gas in the hydrogen tank 211, provided from the temperature sensor St (see FIG. 1). A volume of the hydrogen tank 211 and a volume of the hydrogen supply passage 212 from the hydrogen tank 211 to the main stop valve 213 have been already known. On this account, the amount Nr of hydrogen stored in the hydrogen tank 211 can be calculated based on the pieces of information on the pressure and the temperature of the hydrogen gas. Note that, in the present specification, “amount of hydrogen” indicates a hydrogen amount evaluated by an evaluation method such as a mass or a molar content that does not change depending on a measurement environment. In the present embodiment, the “amount of hydrogen” is evaluated based on the molar content.

A functional part of the vehicle controlling portion 500 that performs such a process is illustrated in FIG. 1 as a hydrogen amount measuring portion 502. The hydrogen amount measuring portion 502 calculates the amount Nr of hydrogen stored in the hydrogen tank 211 at given time intervals.

The vehicle controlling portion 500 further calculates a percent amount Rw of the amount Nr of hydrogen stored in the hydrogen tank 211 to a maximum amount Nmax of hydrogen storable in the hydrogen tank 211. The maximum amount Nmax of hydrogen storable in the hydrogen tank 211 is determined in advance based on the volume of the hydrogen tank 211, an internal pressure tolerable for the hydrogen tank 211, an expected temperature of hydrogen in the hydrogen tank 211, and so on.

The vehicle controlling portion 500 displays a display Dh1 indicative of the percent amount Rw of hydrogen stored in the hydrogen tank 211 and a display Dh2 indicative of the amount Nr of hydrogen stored in the hydrogen tank 211 such that they overlap with the image V211 indicative of the hydrogen tank 211 (see the right upper part in FIG. 2).

The hydrogen stored in the hydrogen tank 211 is gas, so that its volume greatly changes in accordance with temperature and pressure. Because of this, it is not appropriate to evaluate an amount of substance in terms of volume like liquid fuel. However, by performing the process described above, the amount of hydrogen stored in the hydrogen tank 211 as a parameter peculiar to the fuel cell vehicle as a device consuming fuel gas can be clearly informed to the user by an expression in which the amount of hydrogen is evaluated by the evaluation method that does not change depending on a measurement environment.

The vehicle controlling portion 500 changes a display color of the image V211 indicative of the hydrogen tank 211 in accordance with the percent amount Rw of hydrogen stored in the hydrogen tank 211. More specifically, when the percent amount Rw of hydrogen stored in the hydrogen tank 211 is 100 [%], the image V211 indicative of the hydrogen tank 211 is displayed in dark blue. As the percent amount Rw of hydrogen stored in the hydrogen tank 211 decreases, the blue color of the image V211 indicative of the hydrogen tank 211 becomes lighter. When the percent amount Rw of hydrogen stored in the hydrogen tank 211 is zero, the image V211 indicative of the hydrogen tank 211 is displayed in white.

By performing such a process, the amount of hydrogen stored in the hydrogen tank 211 can be informed to the user so that the user can intuitively grasp the amount of hydrogen.

The vehicle controlling portion 500 calculates an amount Nv of hydrogen sent out from the hydrogen tank 211 per unit time, based on the amount Nr of hydrogen stored in the hydrogen tank 211, calculated by the hydrogen amount measuring portion 502 at each timing, and information of each time when the amount Nr of hydrogen is calculated. In the present embodiment, the amount Nv [mol/sec] of hydrogen sent out from the hydrogen tank 211 per second is calculated. The vehicle controlling portion 500 displays, on the display panel 91, a display Dh3 indicative of the amount Nv of hydrogen sent out from the hydrogen tank 211 per second (see the center of the upper part in FIG. 2).

Since hydrogen stored in the hydrogen tank 211 is gas, it is not appropriate to evaluate a fuel consumed speed based on the volume of the fuel like liquid fuel. However, by performing the process described above, the amount of hydrogen sent out from the hydrogen tank 211 per unit time as a parameter peculiar to the vehicle 20 including the fuel cell 100 can be informed to the user by an expression in which the amount of hydrogen is evaluated by the evaluation method that does not change depending on a measurement environment.

The vehicle controlling portion 500 calculates a moving amount Sd of the vehicle 20 per unit time based on latest information from among pieces of information provided from the vehicle speed detection portion 60. Herein, the moving amount Sd [km/h] of the vehicle 20 per hour is calculated. The vehicle controlling portion 500 displays a display Dv1 indicative of the moving amount Sd of the vehicle 20 per hour on the display panel 91 (see the lower part of the center in FIG. 2).

The vehicle controlling portion 500 calculates a moving amount Fe of the vehicle 20 per unit amount of hydrogen based on the amount Nv of hydrogen sent out from the hydrogen tank 211 per unit time and the moving amount of the vehicle 20 per unit time. In the present embodiment, a travel distance Fe [km/mol] per one mole of hydrogen is calculated.

More specifically, the vehicle controlling portion 500 determines a first time interval including (i) a time when the information on the pressure of the hydrogen gas is acquired by the pressure sensor Sp and (ii) a time when the information on the temperature of the hydrogen gas in the hydrogen tank 211 is acquired by the temperature sensor St, those times being used at the time of calculating the amount Nv of hydrogen sent out from the hydrogen tank 211 per unit time. The vehicle controlling portion 500 calculates a moving amount Sd2 of the vehicle 20 per unit time in a second time interval including the first time interval based on an output from the vehicle speed detection portion 60 in the second time interval. Note that the second time interval is a time interval including the first time interval and a time interval in which the vehicle moves. In a case where the vehicle moves in the first time interval, the second time interval may be the same as the first time interval.

The vehicle controlling portion 500 calculates the moving amount Fe [km/mol] of the vehicle 20 per mole of hydrogen based on the amount Nv [mol/sec] of hydrogen sent out from the hydrogen tank 211 per unit time in the first time interval and the moving amount Sd2 [km/h] of the vehicle 20 per unit time in the second time interval.

A functional part of the vehicle controlling portion 500 that performs a process of calculating the amount Nv of hydrogen sent out from the hydrogen tank 211 per unit time is illustrated in FIG. 1 as a fuel efficiency calculation portion 504. The fuel efficiency calculation portion 504 calculates the amount Nv of hydrogen sent out from the hydrogen tank 211 per unit time at given time intervals while the main stop valve 213 is opened and the vehicle 20 moves.

The vehicle controlling portion 500 displays a display De1 indicative of the moving amount Fe of the vehicle 20 per unit amount of hydrogen on the display panel 91 (see the lower part of the center in FIG. 2).

Since hydrogen stored in the hydrogen tank 211 is gas, it is not appropriate to evaluate a moving distance per unit fuel consumed amount based on the volume of the fuel, like liquid fuel. However, by performing the process described above, the moving amount Fe of the vehicle 20 per unit amount of hydrogen as a parameter peculiar to the vehicle 20 including the fuel cell 100 can be informed to the user.

The vehicle controlling portion 500 calculates a movable distance Cd [km] by hydrogen stored in the hydrogen tank 211 based on the weight of the load, acquired from the weight sensor 65 (see the left upper part in FIG. 1), the amount Nr [mol] of hydrogen in the hydrogen tank 211, and the moving amount Fe [km/mol] of the vehicle 20 per unit amount of hydrogen. More specifically, the vehicle controlling portion 500 determines the movable distance Cd [km] by hydrogen stored in the hydrogen tank 211 by performing correction based on the weight of the load on a value obtained by dividing the amount Nr of hydrogen in the hydrogen tank 211 by the moving amount Fe of the vehicle 20 per unit amount of hydrogen.

For example, in a case where a travel route where the vehicle 20 should travel in future is specified to the vehicle controlling portion 500, the vehicle controlling portion 500 calculates a rate of uphill slopes included in each of a travel route where the vehicle 20 has traveled in the second time interval at the time when the moving amount Fe of the vehicle 20 per unit amount of hydrogen has been calculated and the travel route where the vehicle 20 should travel in future. In a case where the number of uphill slopes included in the travel route where the vehicle 20 should travel in future is larger than the number of uphill slopes included in the travel route at the time when the moving amount Fe of the vehicle 20 per unit amount of hydrogen has been calculated, the vehicle controlling portion 500 determines the distance Cd to a smaller value in accordance with the weight of the load. In the meantime, in a case where the number of uphill slopes included in the travel route where the vehicle 20 should travel in future is smaller than the number of uphill slopes included in the travel route at the time when the moving amount Fe of the vehicle 20 per unit amount of hydrogen has been calculated, the vehicle controlling portion 500 determines the distance Cd to a larger value in accordance with the weight of the load. As the weight of the load is smaller, the adjustment amount is smaller.

A functional part of the vehicle controlling portion 500 that performs a process of calculating the movable distance Cd is illustrated in FIG. 1 as a distance calculation portion 506. The distance calculation portion 506 calculates the amount Nv of hydrogen sent out from the hydrogen tank 211 at given time intervals while the main stop valve 213 is opened and the vehicle 20 moves.

The vehicle controlling portion 500 displays, on the display panel 91, a display Dc1 indicative of the movable distance Cd by hydrogen stored in the hydrogen tank 211, obtained by the above process (see the right lower part in FIG. 2).

By performing such a process, the movable distance Cd by hydrogen stored in the hydrogen tank 211 can be correctly informed to the user.

The vehicle controlling portion 500 displays, on the display panel 91, the image V100 of the fuel cell 100, the image VH of hydrogen sent out to the fuel cell 100, and the image VO of oxygen sent out to the fuel cell 100 (see the upper part in FIG. 2).

The image VH of hydrogen sent out to the fuel cell 100 includes a display VH1 of an arrow and a display VH2 of “H2.” The image VH of hydrogen sent out to the fuel cell 100 is displayed in accordance with the amount Nv of hydrogen sent out from the hydrogen tank 211 per unit time.

In the image VH of hydrogen sent out to the fuel cell 100, a part of the display VH1 of the arrow is displayed in a color darker than other parts. The part thus displayed in a dark color repeatedly moves in the display VH1 of the arrow from a side where the image V211 indicative of the hydrogen tank 211 is displayed toward a side where the image V100 indicative of the fuel cell 100 is displayed. A moving speed of the part is higher as the amount Nv of hydrogen sent out from the hydrogen tank 211 per unit time is larger.

By performing such a process, a power generation state of the fuel cell 100 can be informed to the user so that the user can intuitively grasp the power generation state.

The image VO of oxygen sent out to the fuel cell 100 includes a display VO1 of an arrow and a display VO2 of “O₂.” The image VO of oxygen sent out to the fuel cell 100 is displayed in accordance with an amount of oxygen sent out from the atmosphere per unit time.

In the image VO of oxygen sent out to the fuel cell 100, a part of the display VO1 of the arrow is displayed in a color darker than other parts. The part thus displayed in a dark color repeatedly moves in the display VO1 of the arrow from a side where the image VA indicative of the atmosphere is displayed toward a side where the image V100 indicative of the fuel cell 100 is displayed. A moving speed of the part is higher as the amount of oxygen sent out from the atmosphere per unit time is larger.

The display switch button B02 is a button to switch the display to the display D92 (see FIG. 2) indicative of a state where hydrogen is consumed in the fuel cell vehicle 20. On this account, in the display D92, when the display switch button B02 is pressed, the display on the display panel 91 (see the right lower part in FIG. 1) does not change.

The display switch button B03 is a button to switch the display to the display D93 mainly indicative of a moving speed of the fuel cell vehicle 20. In the display D92 in FIG. 2, when the display switch button B03 is pressed, the display on the display panel 91 (see the right lower part in FIG. 1) is changed to the display D93 by the vehicle controlling portion 500.

The display switch button B04 is a button to switch the display to the display D94 mainly indicative of a hydrogen filled state of the hydrogen tank 211 of the fuel cell vehicle 20. In the display D92 in FIG. 2, when the display switch button B04 is pressed, the display on the display panel 91 (see the right lower part in FIG. 1) is changed to the display D94 by the vehicle controlling portion 500.

A functional part of the vehicle controlling portion 500 that controls the display panel 91 such that those various pieces of information are displayed on the display panel 91 is illustrated in FIG. 1 as a display controlling portion 503. Every time various pieces of information to be displayed on the display panel 91 are updated, the display controlling portion 503 updates the display on the display panel 91.

FIG. 3 is a view illustrating the display D93 displayed on the display panel 91 (see the right lower part in FIG. 1). The display D93 is a display mainly indicative of the moving speed of the fuel cell vehicle 20. The display D93 includes displays De2, De3, displays Dv2, Ds1, displays Dh4, Dh5, and the display switch buttons B02 to B04.

The display Dv2 is a display indicative of the moving speed of the fuel cell vehicle 20. The vehicle controlling portion 500 displays, as the display Dv2, a circular meter including speed indication, and a pointer pointing a position on the outer periphery of the circular meter, the position corresponding to the moving speed Sd of the fuel cell vehicle 20 at that time point.

By performing such a process, the moving speed of the fuel cell vehicle 20 at that time point can be informed to the user so that the user can intuitively grasp the moving speed.

The vehicle controlling portion 500 calculates a travel distance in a past given period of time including a present time point based on information provided from the vehicle speed detection portion 60. The display Ds1 indicative of the travel distance is displayed so as to overlap with the display Dv2.

By performing such a process, the travel distance of the fuel cell vehicle 20 at that time point can be informed to the user so that the user can intuitively grasp the travel distance.

The display Dh4 is a display indicative of the amount of hydrogen sent out from the hydrogen tank 211 per unit time. The vehicle controlling portion 500 displays, as the display Dh4, a circular meter including a display gradually increasing in width in accordance with an angular position and indicative of the amount of hydrogen sent out from the hydrogen tank 211 per unit time, and a pointer pointing a position on the outer periphery of the circular meter, the position corresponding to the amount Nv of hydrogen sent out from the hydrogen tank 211 per unit time at that time point.

By performing such a process, the amount of hydrogen sent out from the hydrogen tank 211 per unit time at that time point can be informed to the user so that the user can intuitively grasp the amount of hydrogen.

The display Dh5 is a display indicative of the percent amount Rw of hydrogen stored in the hydrogen tank 211 in the form of a graph. The vehicle controlling portion 500 displays, as the display Dh5, an oblong bar graph in which a display of “E” and a display of “F” are provided in both ends, and a display of “½” is provided in the center. The display of “E” indicates that the percent amount Rw of hydrogen is 0, that is, no hydrogen gas that can be taken out remains in the hydrogen tank 211. The display of “F” indicates that the percent amount Rw of hydrogen is 100%, that is, the maximum amount Nmax of hydrogen storable in the hydrogen tank 211 is stored in the hydrogen tank 211. A part of the bar graph, including the left end, is displayed in a color darker than other parts in accordance with the percent amount Rw of hydrogen stored in the hydrogen tank 211. The vehicle controlling portion 500 displays the display Dh5 in the display Dh4 in an overlapping manner.

By performing such a process, the percent amount Rw of hydrogen stored in the hydrogen tank 211 can be informed to the user so that the user can intuitively grasp the percent amount Rw of hydrogen.

The vehicle controlling portion 500 transmits the moving amount Fe of the vehicle 20 per unit amount of hydrogen to other vehicles via the communication portion 95. Further, the vehicle controlling portion 500 receives moving amounts Fe2, Fe3 of other vehicles per unit amount of hydrogen from those other vehicles via the communication portion 95. The moving amount Fe2 of a first one of the other vehicles per unit amount of hydrogen is a moving amount of a leading vehicle per unit amount of hydrogen, the leading vehicle being a vehicle traveling ahead of the vehicle 20 in the same direction as the vehicle 20. The moving amount Fe3 of a second one of the other vehicles per unit amount of hydrogen is a moving amount of a leading vehicle among oncoming vehicles per unit amount of hydrogen, the oncoming vehicles being vehicles coming toward the vehicle 20 from ahead of the vehicle 20. The vehicle controlling portion 500 displays, on the display panel 91, displays De2, De3 indicative of the moving amounts Fe2, Fe3 of the other vehicles per unit amount of hydrogen as well as images V22, V23 indicative of those vehicles (see the upper part in FIG. 3).

By performing such a process, the moving amounts Fe2, Fe3 of the other vehicles per unit amount of hydrogen, that is, fuel efficiencies of the other vehicles can be informed to the user so that the user can intuitively grasp the moving amounts Fe2, Fe3. As a result, a motivation to drive with a higher fuel efficiency can be given to the user.

Appearances and functions of the display switch buttons B02 to B04 are the same as the display switch buttons B02 to B04 included in the display D92.

FIG. 4 is a view illustrating the display D94 displayed on the display panel 91 (see the right lower part in FIG. 1). The display D94 is a display mainly indicative of a hydrogen filled state of the hydrogen tank 211 of the fuel cell vehicle 20. The display D94 is displayed on the display panel 91 when the opening-closing sensor 218 detects that the cover portion 217 is opened, as well as when the display switch button B04 is pressed on the displays D92, D93. The display D94 includes a display Dh6, displays Dt1, Dt2, and the display switch buttons B02 to B04.

The display Dh6 is a display indicative of the percent amount Rw of hydrogen stored in the hydrogen tank 211 in the form of a graph. The vehicle controlling portion 500 displays, as the display Dh6, an oblong and elliptical bar graph in which a display of “0” and a display of “100” are provided in both ends, and the bar graph imitates the hydrogen tank 211 (see the upper part in FIG. 4). The display of “O0” indicates that the percent amount Rw of hydrogen is 0, that is, no hydrogen gas that can be taken out remains in the hydrogen tank 211. The display of “100” indicates that the percent amount Rw of hydrogen is 100%, that is, the maximum amount Nmax of hydrogen storable in the hydrogen tank 211 is stored in the hydrogen tank 211. A part of the bar graph, including the left end, is displayed in a color darker than other parts in accordance with the percent amount Rw of hydrogen stored in the hydrogen tank 211.

The vehicle controlling portion 500 displays a display Dh7 indicative of the percent amount Rw of hydrogen stored in the hydrogen tank 211 in the form of a numeric character such that the display Dh7 overlaps with the display Dh6 (see the upper part in FIG. 4).

While the cover portion 217 is opened, the vehicle controlling portion 500 repeats, in a given cycle, a process of calculating the percent amount Rw to the maximum amount Nmax of hydrogen storable in the hydrogen tank 211, based on pieces of information from the pressure sensor Sp and the temperature sensor St. Then, based on the latest percent amount Rw obtained as such, the displays Dh6, Dh7 are updated.

By performing such a process, the percent amount Rw of hydrogen stored in the hydrogen tank 211 can be informed to the user during filling of hydrogen so that the user can intuitively grasp the percent amount Rw of hydrogen.

The display Dt1 is a display indicative of an accumulation value of a filling time of hydrogen. The display Dt2 is a display indicative of an estimated value of an accumulation value of a charge time that should have been required for charging in a case of a battery electric vehicle.

The vehicle controlling portion 500 accumulates a time Tf1 required to fill hydrogen into the hydrogen tank 211 from the outside based on information provided from the opening-closing sensor 218, the information indicating that the cover portion 217 is opened (see the right upper part in FIG. 1). More specifically, the vehicle controlling portion 500 accumulates a length of a time interval during which the cover portion 217 is opened and the vehicle 20 stops after time TO set in advance, as a time required to fill hydrogen into the hydrogen tank 211 from the outside. Information indicating that the vehicle 20 stops is provided from the vehicle speed detection portion 60. The time can be measured by the vehicle controlling portion 500. A functional part of the vehicle controlling portion 500 that performs such a process is illustrated in FIG. 1 as a time accumulation portion 507.

The vehicle controlling portion 500 calculates an electric power amount Ei generated by the fuel cell 100 after time TO set in advance, based on pieces of information provided from the current sensor Si and the voltage sensor Sv (see the left upper part in FIG. 1). The vehicle controlling portion 500 calculates an estimated value Tf2 of an accumulation value of a charge time that should have been required to charge a nickel-metal hydride battery with the electric power amount Ei. Note that the vehicle controlling portion 500 holds, in advance, information of a model of the nickel-metal hydride battery assumed when the estimated value Tf2 is calculated. A functional part of the vehicle controlling portion 500 that performs such a process is the time accumulation portion 507 (see the right lower part in FIG. 1).

The vehicle controlling portion 500 displays, on the display panel 91, the display Dt1 indicative of the time Tf1 required to fill hydrogen into the hydrogen tank 211 from the outside (see the middle part in FIG. 4).

By performing such a process, the accumulation value Tf2 of time required to fill hydrogen into the hydrogen tank 211 can be informed to the user.

The vehicle controlling portion 500 displays, on the display panel 91, the display Dt1 indicative of the time Tf1 required to fill hydrogen into the hydrogen tank 211 from the outside and the display Dt2 indicative of the estimated value Tf2 of the accumulation value of the charge time that should have been required to charge the nickel-metal hydride battery (see the lower part in FIG. 4).

By performing such a process, the user can specifically know superiority in time required for filling of energy in a case where the vehicle 20 as a fuel cell vehicle is used with respect to a case where a battery electric vehicle is used.

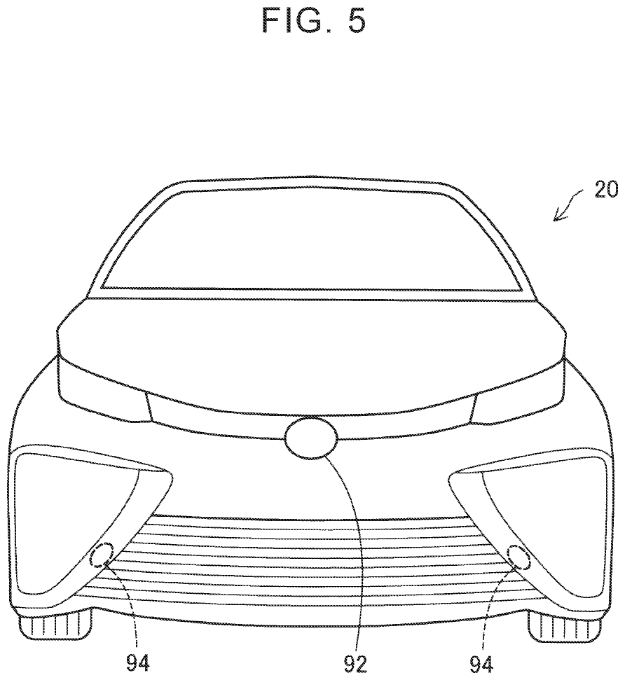

FIG. 5 is a front view of the vehicle 20. In a case where the moving amount Fe of the vehicle 20 per unit amount of hydrogen does not exceed a threshold, the vehicle controlling portion 500 causes the emblem 92 and the light emission portions 94 to emit light in orange (see the left part in FIG. 1). In a case where the moving amount Fe of the vehicle 20 per unit amount of hydrogen exceeds the threshold, the vehicle controlling portion 500 causes the emblem 92 and the light emission portions 94 to emit light in blue.

By performing such a process, a user who drives in consideration of reduction of an environmental load can discriminate himself or herself from a user who drives without such an intention.

Note that the fuel cell vehicle 20 in the present embodiment is also referred to as “movable body.” The hydrogen tank 211 is also referred to as “storage portion.” The pressure sensor Sp, the temperature sensor St, and the hydrogen amount measuring portion 502 are also referred to as “remaining amount measuring portion.” The display panel 91 is also referred to as “display portion.” The display controlling portion 503 is also referred to as “controlling portion.” The vehicle speed detection portion 60 is also referred to as “moving amount measuring portion.” The weight sensor 65 is also referred to as “load measuring portion.” The opening-closing sensor 218, the vehicle speed detection portion 60, and the time accumulation portion 507 are also referred to as “time accumulation portion.”

### B. Modifications

B1. Modification 1:

(1) The above embodiment deals with an example in which the display panel 91 provided with a touch panel is used as a display portion on which information is displayed. However, the display portion can be configured such that an input device such as a touch panel is not provided. The display portion can be provided in various aspects such as a liquid crystal display and a plasma display panel. Further, the display portion is not limited to a flat shape and may be configured such that information is displayed on a curved surface or information is displayed in space.

(2) In the above embodiment, the storage portion in which fuel gas is stored is the hydrogen tank 211 (see the right lower part in FIG. 1). However, the storage portion can be configured such that hydrogen absorbing alloy is stored in the storage portion. In such an aspect, a remaining amount measuring portion can measure the amount of the fuel gas in the storage portion in terms of mass, for example.

(3) In the above embodiment, the amount of the hydrogen gas as the fuel gas is evaluated in terms of “mol” (see Dh2 in FIG. 2). However, the amount of the fuel gas may be evaluated by other evaluation methods such as mass. Note that the amount of the fuel gas is evaluated by an evaluation method that does not change depending on a measurement environment.

(4) In the above embodiment, the remaining amount measuring portion that can measure an amount of hydrogen in the hydrogen tank 211 includes the hydrogen amount measuring portion 502 as a functional part of the vehicle controlling portion 500, the pressure sensor Sp provided in the hydrogen supply passage 212, and the temperature sensor St provided in the hydrogen tank 211 (see the right part in FIG. 1). However, the remaining amount measuring portion that can measure the amount of the fuel gas in the storage portion can have other configurations. For example, the remaining amount measuring portion can be constituted by: (i) a flow rate sensor and a temperature sensor provided in the hydrogen supply passage 212; (ii) a flow rate sensor and a temperature sensor provided in the hydrogen receipt passage 216; and (iii) the vehicle controlling portion 500 configured to detect an amount of hydrogen flowing into the hydrogen tank 211 and an amount of hydrogen sent out from the hydrogen tank 211 based on respective outputs from the flow rate sensors and the temperature sensors so as to find a difference between these amounts of hydrogen as an amount of hydrogen in the hydrogen tank 211.

(5) In the above embodiment, the display Dh2 indicative of the amount Nr of hydrogen stored in the hydrogen tank 211 and the display Dh1 indicative of the percent amount Rw of hydrogen stored in the hydrogen tank 211 in the form of a numerical character are displayed on the image V211 indicative of the hydrogen tank 211 in an overlapping manner (see the right upper part in FIG. 2). However, the amount of the fuel gas stored in the storage portion, displayed on the display portion based on information provided from the remaining amount measuring portion, can be displayed in other forms. The amount of the fuel gas stored in the storage portion can be displayed in the form of an image of a bar graph or a round or sectorial meter.

(6) In the above embodiment, the display Dh4 indicative of the amount of hydrogen sent out from the hydrogen tank 211 per unit time is expressed by the pointer and the circular meter including a display indicative of the amount of hydrogen sent out from the hydrogen tank 211 per unit time, the display gradually increasing in width in accordance with an angular position. However, the display indicative of the amount of hydrogen sent out from the hydrogen tank 211 per unit time can be expressed by a circular or sectorial meter including values indicative the amount of hydrogen, and a pointer pointing a position on the outer periphery of the meter, the position corresponding to the amount of hydrogen sent out from the hydrogen tank 211 per unit time at that time point. Further, the display indicative of the amount of hydrogen sent out from the hydrogen tank 211 per unit time can be expressed in the form of a bar graph.

(7) In the above embodiment, the vehicle controlling portion 500 displays, on the display panel 91, the displays De2, De3 indicative of the moving amounts Fe2, Fe3 of other vehicles per unit amount of hydrogen as well as the images V22, V23 indicative of those vehicles (see the upper part in FIG. 3). Such displays can be displayed while a driver can actually see those other vehicles. In the meantime, such displays can be displayed before the driver can actually see those other vehicles. [0103] (8) In the above embodiment, display modes can be selected for some of the displays D92 to D94 displayed on the display panel 91 (see FIGS. 2 to 4). For example, in the display D93 in FIG. 3, information selected by the user can be displayed on the right side of the display Dv2. That is, the user can select a mode to be displayed on the display portion from various display modes in terms of the same information described above.

Meanwhile, the user may not be able to select some of the displays on the display portion. For example, in terms of information for which a given display mode is decided by regulation, the information is displayed in accordance with the regulation, and in terms of information for which no regulation is determined, the user may be able to select a display mode.

The display mode selectable by the user may be prepared in advance or the user may acquire an application program provided from a third party and apply the application program to the display device.

(9) Further, for example, the displays Dh6, St1, Dt2 in FIG. 4 can be displayed above the displays Dv2, Dh4 illustrated in FIG. 3 during filling of hydrogen. Further, some constituents of the display D92 to D94 can be displayed on the display portion in combination with other constituents.

(10) In the above embodiment, the displays D92 to D94 are consistent in the vehicle 20 (see FIGS. 2 to 4). However, the vehicle 20 may be configured such that the vehicle controlling portion 500 can obtain information that can specify a driver via the communication portion 95, various parameters may be calculated for each driver, and a display based on information corresponding to the driver may be displayed on the display portion. Such changing of displays can be performed via a button as hardware or a button of software displayed on the display portion. Also, in a case where the driver uses a different vehicle, information corresponding to the driver is collected, so that display based on the information corresponding to the driver may be displayed in a vehicle to be driven by the driver.

(11) In a case where the amount Nr of hydrogen stored in the hydrogen tank 211 or the movable distance Cd by hydrogen stored in the hydrogen tank 211 becomes lower than a threshold, the vehicle can have a function to automatically make a reservation for filling at a hydrogen station provided in the travel direction or a hydrogen station around the home. In such a configuration, the user can restrain such a situation that, when the vehicle reaches the hydrogen station, the vehicle cannot be filled with hydrogen sufficiently because hydrogen held in the hydrogen station is insufficient.

(12) In the above embodiment, in a case where the moving amount Fe of the vehicle 20 per unit amount of hydrogen does not exceed a threshold, the vehicle controlling portion 500 causes the emblem 92 and the light emission portion 94 to emit light in orange (see FIG. 5 and the left part in FIG. 1). In a case where the moving amount Fe of the vehicle 20 per unit amount of hydrogen exceeds the threshold, the vehicle controlling portion 500 causes the emblem 92 and the light emission portion 94 to emit light in blue. However, such a configuration that the display changes in accordance with the moving amount of the vehicle per unit amount of hydrogen may be disposed in a fuel cell case inside the vehicle or around the fuel cell case, for example. Further, a component configured to emit light may be disposed so that light can be observed from a lower part of a vehicle body or a gap between a bonnet and the body. With such a configuration, other people can recognize that the fuel cell vehicle can travel, even from a distant place at night. As a result, it is possible to increase satisfaction of the driver.

Note that, other than a configuration in which light can be emitted, a configuration in which various sounds can be emitted may be employed, and the sounds may change in accordance with whether the moving amount Fe of the vehicle 20 per unit amount of hydrogen exceeds a threshold or not.

(13) The vehicle can be configured such that, after the fuel gas used for a reaction and discharged from the fuel cell is mixed with other chemical compounds, a resultant gas is discharged from a discharge pipe so that the resultant gas is burnt.

(14) In the above embodiment, the fuel gas is hydrogen (see the right lower part in FIG. 1). However, the fuel for the movable body including the fuel cell can be other gases containing hydrogen, e.g., methane, ethane, or the like. Hydrogen can be produced by reforming hydrocarbon and supplied to the fuel cell.

(15) In the above embodiment, the movable body is a vehicle including wheels (see FIG. 1). However, the movable body that can move can have other configurations of a vessel, an aircraft, and the like. Further, the movable body can be a vehicle traveling over a raceway.

B2. Modification 2:

(1) In the above embodiment, the image V211 of the hydrogen tank 211 is displayed on the display panel 91 at a concentration corresponding to the amount of hydrogen gas stored in the hydrogen tank 211, based on information provided by the remaining amount measuring portion (see the right upper part in FIG. 2). However, the image of the storage portion may be the same without depending on the amount of the fuel gas stored in the storage portion. Further, the display device can be configured such that the image of the storage portion is not displayed on the display portion.

(2) In the above embodiment, a value indicative of the amount of the hydrogen gas stored in the hydrogen tank 211 is displayed so as to overlap with the image V211 of the hydrogen tank 211 (see the right upper part in FIG. 2). However, the value indicative of the amount of the fuel gas stored in the storage portion can be displayed in other parts without overlapping with the image of the storage portion.

B3. Modification 3:

In the above embodiment, the amount of the fuel gas sent out from the hydrogen tank 211 per unit time is displayed as a value on the display panel 91 based on information provided from the remaining amount measuring portion (see Dh3 in FIG. 2). However, the amount of the fuel gas sent out from the hydrogen tank 211 per unit time may be displayed as a still image or a moving image without displaying a numeric character (see VH1 in FIG. 2). Further, the display device may be configured such that the amount of the fuel gas sent out from the storage portion per unit time is not displayed on the display portion.

B4. Modification 4:

(1) In the above embodiment, the vehicle controlling portion 500 calculates the moving amount Sd of the vehicle 20 per unit time based on latest information from among pieces of information provided from the vehicle speed detection portion 60 (see the right lower part in FIG. 1). However, the moving amount measuring portion that can measure the moving amount of the movable body can have other configurations, e.g., a sensor that can measure the rotation number of the rotating shaft of the wheel. Further, the moving amount of the movable body can be obtained by integrating twice the output from an acceleration sensor provided in the vehicle.

(2) In the above embodiment, the moving amount of the vehicle 20 per unit amount of hydrogen gas is displayed on the display panel 91 in terms of [km/mol] (see the lower part in FIG. 2). However, the display device can employ [m] instead of [km]when the moving amount per unit amount of the hydrogen gas is displayed. Further, the display device can employ [/kg] instead of [/mol] when the moving amount per unit amount of the hydrogen gas is displayed. The display device can further employ other units when the moving amount per unit amount of the hydrogen gas is displayed. Further, the display device can be configured not to display the moving amount of the movable body per unit amount of the fuel gas on the display portion.

(3) In the above embodiment, the second time interval during which the moving amount Fe of the vehicle 20 per unit amount of hydrogen is calculated includes the first time interval. However, the second time interval can be configured not to include a part of the first time interval. That is, the second time interval may be a time interval at least partially overlapping with the first time interval.

B5. Modification 5:

(1) In the above embodiment, the weight sensor 65 detects a deformation amount of a support member that supports the rotating shafts of the wheels of the fuel cell vehicle 20 and calculates the weight of the load (see the left upper part in FIG. 2). However, the load measuring portion configured to measure the weight of the load put on the movable body can have other configurations. The load measuring portion can have other configurations in which the weight is measured when the load measuring portion is weighted with the load, for example.

(2) In the above embodiment, the movable distance Cd [km] by hydrogen stored in the hydrogen tank 211 is determined based on a value obtained by dividing the amount Nr of hydrogen in the hydrogen tank 211 by the moving amount Fe of the vehicle 20 per unit amount of hydrogen, the weight of the load, and the rate of uphill slopes included in the travel route (see the right lower part in FIG. 2). However, in a case where the travel route is undetermined, after the rate of uphill slopes in the undetermined travel route is estimated based on the topography in a direction where the vehicle is heading, the movable distance by the fuel gas stored in the storage portion can be estimated.

Further, the movable distance by the fuel gas stored in the storage portion can be calculated based on the weight of the load, acquired from the load measuring portion, the amount of the fuel gas stored in the storage portion, and the moving amount of the movable body per unit amount of the fuel gas, without considering the rate of uphill slopes included in the travel route. Further, the display device can be configured so as not to display the movable distance by the fuel gas stored in the storage portion.

B6. Modification 6:

(1) In the above embodiment, the image V211 indicative of the hydrogen tank 211, the image VH of hydrogen sent out from the hydrogen tank 211 to the fuel cell 100, and the image VO of oxygen sent out from the atmosphere to the fuel cell 100 are displayed on the display panel 91 (see the center of the upper part in FIG. 2). A dark part in the display VH1 of the arrow repeatedly moves from the image V211 indicative of the hydrogen tank 211 toward the image V100 indicative of the fuel cell 100. A moving speed of the part is higher as the amount Nv of hydrogen sent out from the hydrogen tank 211 per unit time is larger. At the same time, the display Dh3 indicative the amount Nv of hydrogen sent out from the hydrogen tank 211 per second is displayed on the display panel 91.

In the above aspect, the number of dark parts in the display VH1 of the arrow may increase or decrease in accordance with the amount Nv of hydrogen sent out from the hydrogen tank 211 per unit time. For example, the number of dark parts in the display VH1 of the arrow may increase as the amount Nv of hydrogen sent out from the hydrogen tank 211 per unit time is larger.

Further, the dark part in the display VH1 of the arrow can be displayed such that a boundary between the dark part and other parts is not clear. Further, the display VH1 including such a part may not be the arrow and may be other shapes such as a rectangular shape or a shape that imitates a pipe for hydrogen.

Note that, in the image displayed on the display panel 91, the part displayed in a color darker than other parts can be displayed in a color different from other parts without depending on the concentration, instead of the color darker than other parts.

(2) The display device can be configured to display a state where oxygen molecules react with hydrogen molecules by a moving image. In such a configuration, it is preferable to display the moving image such that the moving image moves more actively as the amount Nv of hydrogen sent out from the hydrogen tank 211 per unit time is larger.

(3) Note that the image of the fuel gas sent out to the fuel cell may be the same image without depending on the amount of the fuel gas sent out from the storage portion per unit time. Further, the display device can be also configured not to display, on the display portion, the image of the fuel cell, the image of the fuel gas sent out to the fuel cell, and the image of the oxidation gas sent out to the fuel cell.

B7. Modification 7:

(1) In the above embodiment, the vehicle controlling portion 500 accumulates a length of the time interval during which the cover portion 217 is opened and the vehicle 20 stops, as a time required to fill hydrogen into the hydrogen tank 211 from the outside (see the right upper part in FIG. 1). However, the method for accumulating the time required to fill the fuel gas into the storage portion from the outside may be other methods. For example, the time required to fill the fuel gas may be received from the gas station from which the fuel gas is filled, via the communication portion 95.

(2) In the above embodiment, the time Tf1 required to fill hydrogen from the outside and the estimated value Tf2 of the accumulation value of the charge time that should have been required for charging in a case of a battery electric vehicle are displayed on the display panel 91 (see the lower part in FIG. 4). However, the time Tf1 required to fill hydrogen from the outside may be displayed on the display panel 91 without the estimated value Tf2 of the accumulation value of the charge time that should have been required for charging in a case of a battery electric vehicle. Further, the display device can be configured not to display the accumulated value of the time required to fill the fuel gas on the display portion.

(3) In the above embodiment, the time Tf1 required to fill hydrogen from the outside and the estimated value Tf2 of the accumulation value of the charge time that should have been required for charging in a case of a battery electric vehicle are displayed on the display panel 91 (see the lower part in FIG. 4). However, the vehicle and the display device can be configured such that a time to fill the fuel gas while the vehicle moves by a unit distance, e.g., 1000 km is accumulated, and the filling time and an estimated value in a case of an electric vehicle are displayed, for example.

The disclosure is not limited to the above embodiments and is achievable in various configurations within a range that does not deviate from the gist of the disclosure. For example, technical features of the embodiments, corresponding to the technical features of the aspects described in SUMMARY, can be replaced or combined appropriately, in order to solve some or all of the problems described above or in order to achieve some or all of the above effects. Further, the technical features can be deleted appropriately if the technical features have not been described as essential in the present specification.

What is claimed is:

1. A display device for displaying information, the display device being provided in a movable body including a fuel cell, a storage portion in which fuel gas to be supplied to the fuel cell is stored, and a remaining amount measuring portion configured to measure an amount of the fuel gas in the storage portion, the display device comprising:
a display portion on which the information is displayed; and
a controlling portion configured to control the display portion, wherein the controlling portion displays, on the display portion, the amount of the fuel gas stored in the storage portion based on information provided from the remaining amount measuring portion.

2. The display device according to claim 1, wherein:
the controlling portion displays, on the display portion, an image of the storage portion in accordance with the amount of the fuel gas stored in the storage portion based on the information provided from the remaining amount measuring portion; and
the controlling portion displays, on the display portion, a value indicative of the amount of the fuel gas stored in the storage portion such that the value overlaps with the image of the storage portion.

3. The display device according to claim 1, wherein the controlling portion displays, on the display portion, an amount of the fuel gas sent out from the storage portion per unit time based on the information provided from the remaining amount measuring portion.

4. The display device according to claim 3, wherein:
the movable body further includes a moving amount measuring portion configured to measure a moving amount of the movable body; and
the controlling portion displays, on the display portion, a moving amount of the movable body per unit amount of the fuel gas based on
the amount of the fuel gas sent out from the storage portion per unit time, calculated based on the information provided from the remaining amount measuring portion, the amount of the fuel gas being an amount of the fuel gas sent out from the storage portion per unit time during a first time interval, and
a moving amount of the movable body per unit time, calculated based on the information provided from the moving amount measuring portion, the moving amount being a moving amount of the movable body per unit time during a second time interval at least partially overlapping with the first time interval.

5. The display device according to claim 4, wherein:
the movable body further includes a load measuring portion configured to measure a weight of a load put on the movable body; and
the controlling portion displays, on the display portion, a movable distance by the fuel gas stored in the storage portion, based on
the weight of the load, provided from the load measuring portion,
the amount of the fuel gas stored in the storage portion, calculated based on the information provided from the remaining amount measuring portion, and
the moving amount of the movable body per unit amount of the fuel gas.

6. The display device according to claim 3, wherein:
the controlling portion displays, on the display portion, an image of the fuel cell, an image of the fuel gas sent out to the fuel cell, and an image of oxidation gas sent out to the fuel cell; and
the image of the fuel gas sent out to the fuel cell is displayed in accordance with the amount of the fuel gas sent out from the storage portion per unit time.

7. The display device according to claim 1, wherein:
the movable body further includes a time accumulation portion configured to accumulate a time required to fill the fuel gas into the storage portion from outside; and
the controlling portion displays, on the display portion, an accumulation value of the time acquired from the time accumulation portion.
